(19) United States
(12) Patent Application Publication
(10) Pub. No.: US 2006/0118985 A1
(43) Pub. Date: Jun. 8, 2006

(54) Method of producing a composite component and deep-drawing mold for same

(75) Inventors: Herbert Beck, Wolfenbuettel (DE); Matthias Ludwig, Vechelde (DE); Tobias Niesner, Gifhorn (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/292,648

(22) Filed: Dec. 2, 2005

(30) Foreign Application Priority Data
Dec. 3, 2004 (EP) 04 028 715.3

(51) Int. Cl. B29C 44/12; B29C 51/08; B29C 51/10; B29C 51/12

(52) U.S. Cl. 264/46.8; 264/553; 264/511; 264/265; 264/161

(57) ABSTRACT

A method of producing a composite component uses a deep-drawing mold with indentations or raised portions. Slots are provided in the deep-drawing mold at each corner of these indentations or raised portions. Air is sucked off through the slots during deep-drawing.

### BACKGROUND OF THE INVENTION

The application claims priority to European Application No. 04 028 715.3, which was filed on Dec. 3, 2004.

The invention relates to a method of producing a composite component, in particular a large-surface vehicle body attachment part, as well as to a deep-drawing mold for deep-drawing a foil to be provided with a foamed or injection-molded backing.

Vehicle body attachment parts are those parts that define a portion of an outer skin in a completely mounted state of the vehicle, and which are secured to a vehicle body. Such vehicle body attachment parts include vehicle roofs, doors, door exterior linings, flaps such as hatchbacks or engine hoods, fenders, bumpers, wind deflectors etc., for example. These vehicle body attachment parts can be produced in a simple manner by using a foil, in particular a plastic or aluminum foil, which is provided with a foamed or injection-molded backing to form a composite component.

Having produced the composite component, the foil constitutes a visible outer skin of the vehicle. Large-area composite components, which have a thickness that is by far smaller than their visible outer surface, are provided with beads for technical or aesthetic reasons. For aesthetic appeal, these beads should have a relatively shaped edge or square-edged cross-sectional shape. Even a step-like shoulder is considered as a bead in this context.

For the formation of this bead, a deep-drawing mold has an indentation or raised portion formed by two surfaces meeting along a line of intersection. A bottom of the bead is formed by the line of intersection. Holes of a suction channel open out into the line of intersection so that the foil receives the correspondingly desired edge during deep-drawing. Due to a vacuum which is applied during deep-drawing, any air between the foil and deep-drawing mold will be sucked off, and the foil is drawn into a corner of the indentation, as seen in cross-section. A deep-drawing mold is a part of the deep-drawing tool and is for deep-drawing foils. The deep-drawing mold is not part of the final product, i.e. the composite component.

It is the object of the invention to provide a method and a deep-drawing mold which provides for a better surface quality of the outer skin of the composite component.

### SUMMARY OF THE INVENTION

The method of producing a composite component according to the invention includes the following steps. A deep-drawing mold having an elongated, angular indentation or raised portion is used to form an elongated, square-edged bead in foil that defines an outer skin of a finished composite component. The indentation or raised portion is formed by two surfaces meeting along a line of intersection. The foil is placed in a deep-drawing tool provided with the deep-drawing mold. The foil is sucked in through a slot provided in the deep-drawing mold, and runs along the line of intersection. The slot constitutes an extension of a suction channel. The foil is deep-drawn. The suction process may commence before deep-drawing, however, at least during the deep-drawing process a suction effect occurs.

The suction takes place via a very long, narrow slot rather than through small suction holes spaced away from each other. Other than the suction holes, the slot will not become apparent in the plastically deformed, deep-drawn foil, so that the composite component has a higher aesthetic quality.

Moreover, as determined during testing, the bottom of the bead, or more generally the corners or edges of the bead, are formed so as to be definitely more sharp-edged than with the spaced suction holes. Beads are in particular starting points of raised portions such as build-ups or other convex contours that directly adjoin the bead. It should be understood that the finished composite component does not necessarily have to have a bead in the region of the line of intersection, but could instead have an edge protruding outwards. A bead can be produced by deep-drawing, but if the foil is turned, the bead will be a protrusion that can be provided with a foamed or injection-molded backing.

With a preferred embodiment, however, the foil is provided with a foamed or injection-molded backing on a side that faces the deep-drawing mold provided with the slot.

The composite component preferably is a large-area vehicle body attachment part.

The foil used for deep-drawing is, for instance, a multilayered coextrusion foil with an outer layer that has an outstanding resistance to scratching. It is preferred that the foil is dyed throughout, so that the composite component will not be lacquered.

According to the preferred embodiment, the foil has a thickness of at least 1 mm, preferably more than 1.2 mm.

In order to be able to build up the vacuum in the region of the slot as quickly as possible, a plurality of suction channels or suction holes are provided that open out into the slot.

The width of the slot depends on the foil thickness and/or the shape of the bead and, above all, on the radius at the bottom of the bead. The slot should have a maximum width of approximately 0.8 mm. More generally, the maximum slot width should amount to half the radius of curvature at the line of intersection. The maximum slot width should amount to 60%, preferably even to 50% of the foil thickness, as it is defined in a preferred embodiment.

The foil is trimmed after the deep drawing. The foil is also preferably trimmed before or after the foamed or injection-molded backing has been applied, with the bead being situated in the portion that is not severed, i.e. in a visible part of the finished composite component.

The slot extends substantially along the entire length of the indentation or raised portion, so that irritating marks on the foil are avoided.

The invention further relates to a deep-drawing mold for deep-drawing a foil that is provided with a foamed/injection-molded backing. The deep-drawing mold has a contact surface provided for the foil, and comprises an elongated indentation or raised portion formed by two surfaces meeting along a line of intersection. A suction channel is also provided in the deep-drawing mold. The deep-drawing mold according to the invention provides that, along the line of intersection, the contact surface has an elongated slot in fluid communication with the suction channel. The slot has already been described above in detail in connection with the method according to the invention. All the details which have been mentioned above are optionally to be seen as the details of the deep-drawing mold itself.

According to one embodiment, the indentation or raised portion has a U-shaped cross-sectional shape, with the corners of the “U” each being provided with one slot running in a longitudinal direction. Other embodiments implement a V-shaped groove.

These and other features of the present invention can be best understood from the following specification and drawings, the following of which is a brief description.

### BRIEF DESCRIPTION OF THE DRAWINGS

FIG. 1 is a perspective top view of a deep-drawing mold of a deep-drawing tool according to the invention, with a superimposed deep-drawn foil that is already adapted to the contour.

FIG. 2 is an enlarged view of the front, right-hand corner region of the deep-drawing mold according to FIG. 1.

FIG. 3 is a cross-sectional view through the deep-drawing tool along line III-III in FIG. 2.

FIG. 4 is a schematic sectional view through a tool for making a foamed or injection-molded backing, with a finished, foamed or injection-molded composite component according to the invention.

FIG. 5 shows a vehicle front piece with an engine hood produced according to the invention.

### DETAILED DESCRIPTION OF THE PREFERRED EMBODIMENT

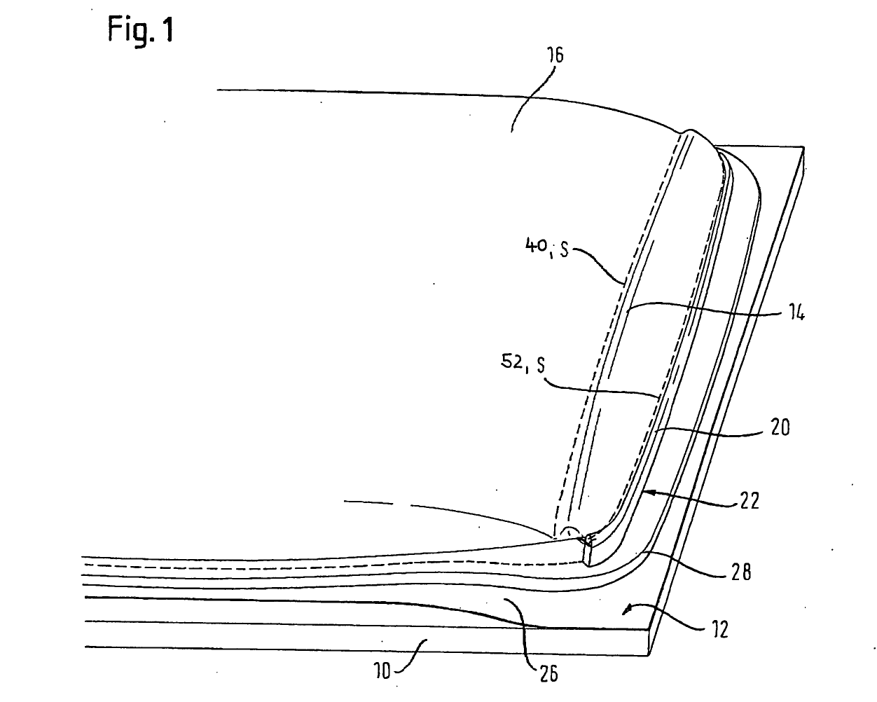

FIG. 1 shows a right half of a deep-drawing mold 10. The deep-drawing mold serves for deep-drawing a multilayered coextrusion foil 12 that has a thickness of at least 1 mm, and which is dyed throughout. As shown in FIG. 1, this foil 12 is already placed on a contact surface (upper side) of the deep-drawing mold 10, has already been deep-drawn, and therefore reflects the contour of the contact surface.

The foil 12, delivered in the form of thin plates, is deep-drawn in a deep-drawing tool and later on will form an outer skin of a large-area body attachment part. In the present case the body attachment part is a vehicle roof module. As can be seen in FIGS. 1 to 3, the outer skin (i.e. the foil 12) has a bulging bar 14 protruding upwards and extending in a longitudinal direction of a vehicle on an outer rim of the future roof module. This bar 14 is raised compared to the remaining, curved inner portion 16 of the roof. The bar 14 extends towards the outer rim as far as to a U-shaped bead 18, which is in the form of a water drain gutter. The U-shaped bead 18 is followed by a lateral build-up 20, which in turn is followed by a similar U-shaped bead 22. A lateral flange rim 26 extends from the bead 22 across an entire rim of the foil 12. In other words it is circumferentially closed. The flange rim 26 has a shoulder 28.

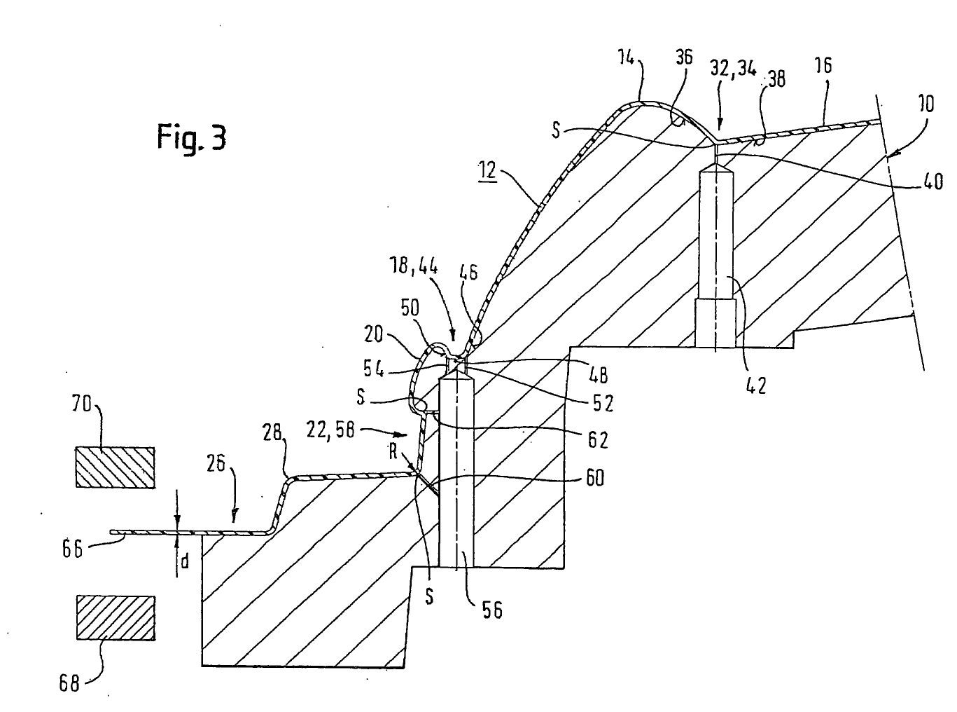

The deep-drawing mold 10 has several indentations and raised portions, which are provided for forming beads in the foil 12. Provided between the inner portion 16 and the bar 14 is a sharp-edged, V-shaped indentation 32 (FIG. 3) in the deep-drawing mold 10 for forming a bead 34 in the foil 12. The indentation 32 is generated by two surfaces 36, 38 meeting along a line of intersection S, with the surface 36 defining a raised portion. A thin, elongated slot 40 extends along the line of intersection S. Numerous suction holes 42, which are spaced from each other perpendicular to the drawing plane, act as suction channels and open out into this slot 40.

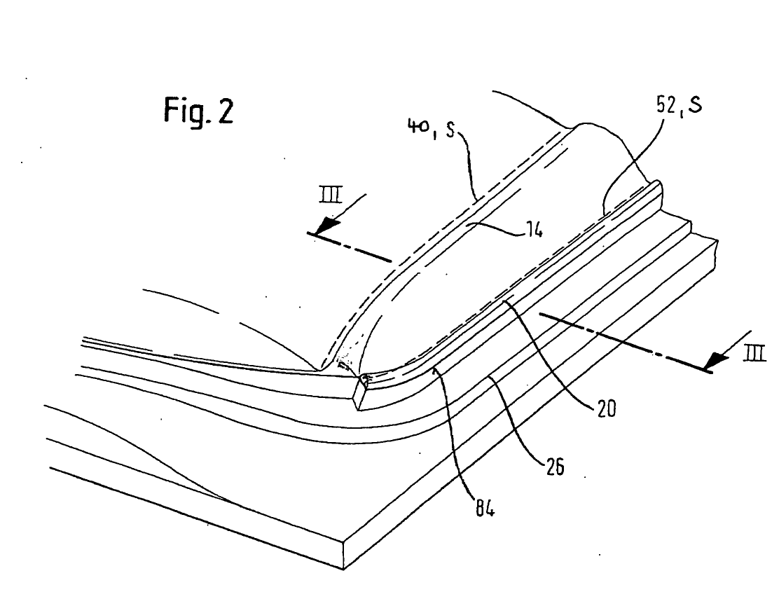

As can be seen in FIG. 1, slot 40 extends along an entire length of the indentation 32 (FIG. 3). Slot 40 is illustrated with broken lines in FIG. 1, because the slot 40 is situated underneath foil 12. For better illustration, the edges produced by the beads 34, 38 are not illustrated as lines in FIGS. 1 and 2. In the drawing they coincide with the slots 40, 52 and the lines of intersections S. The slots 40, 52, however, are continuous. Discontinuous slots with an appearance similar to a perforation are actually possible, but there is a risk that the longitudinal ends of the slots may become apparent in the foil 12. In the invention the slots are very narrow, significantly narrower than the suction holes used up to now. Due to this circumstance, the foil 12 will not be drawn into the slots 40, 52. By the suction area, which is enlarged due to the length of the slots 40, 52, however, the suction effect is improved, the suction itself is accelerated and the quality of the product is better.

Bead 18 is formed by an indentation 44 in the deep-drawing mold 10. At the corners of the “U”, where surfaces 46, 48 and surfaces 48, 50 meet each other, there is provided two slots 52, 54 that extend along an entire length of the indentation 44. The indentation 44 is delimited by raised portions (surfaces 46, 50), with the terms “indentation” and “raised portion” being relative terms that depend on the reference plane. The “corners” of the indentation 44 thus form elongated lines of intersections S, with the slots 52, 54 opening out here. Reference numeral S, however, is omitted here for improving the clarity. The slots 52, 54 open out into shared suction holes 56.

Also, an indentation 58 provided in the deep-drawing mold 10 and associated to bead 22, is defined by slots 60, 62 at the corners, i.e. at the lines of intersections S of meeting surfaces. The respective slots have the reference numerals 60, 62 and likewise are connected with the suction holes 56 in terms of flow.

All slots extend along substantially the entire length of the respective indentation/raised portion in the edge portion of the indentation/raised portion. The slots have a maximum width of 0.8, preferably 0.6 mm and are produced by sawing, milling, etching or laser cutting.

The production of the body attachment part is described below. At first, the foil 12 is clamped in a region of its outer circumferential rim 66 by a clamping frame 68, 70, and is placed in the deep-drawing tool and heated by an inserted heating element. Subsequently, the heated deep-drawing mold 10 is moved upwards in order to plastically deform the foil 12, and subject the foil 12 to deep-drawing. During the deep-drawing process a vacuum is applied at the suction channel, i.e. the suction holes 42, 56, so that no air will remain between the foil 12 and the deep-drawing mold 10 in the regions of the corners of the indentations 32, 44, 58, and the foil 12 is sucked into the corners.

This makes a foil 12 with sharp tear-off edges in the beads 18, 22, 34, and even undercuts in the deep-drawing direction (see bead 22). The slots cannot be seen on the finished foil 12. The maximum width of the slots preferably amounts to half a radius R at the line of intersection S concerned. For more clarity, there has been illustrated only one radius R in FIG. 3, with the understanding that this also applies to the other lines of intersection. Further, the maximum width of each slot amounts to 50 or 60% of the foil thickness d.

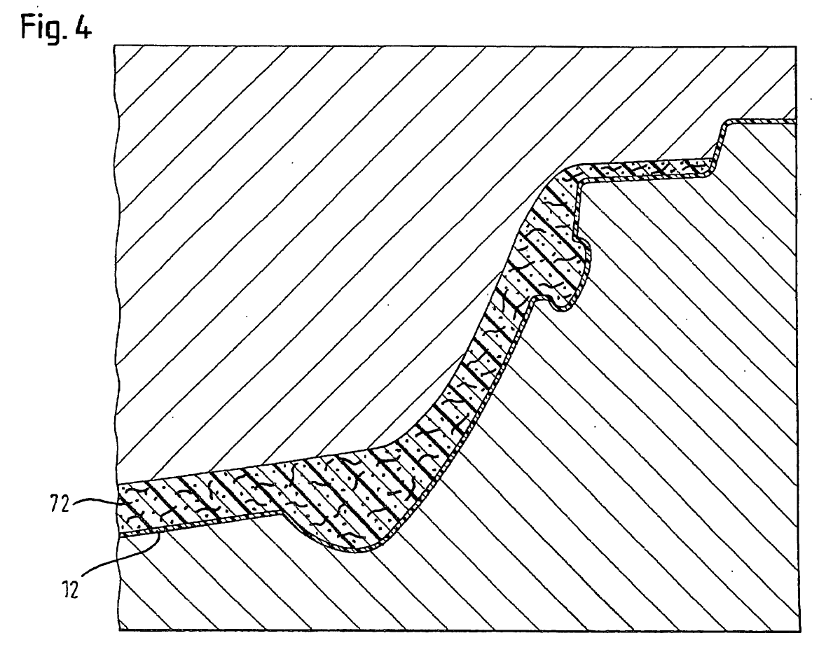

After having deep-drawn the foil 12, the foil 12 is removed from the deep-drawing tool and placed in a foaming or injection-molding mold (see FIG. 4). The rear of the foil 12, namely a side which rests at the deep-drawing mold 10, is oriented towards the top. Liquid polyurethane (PU) material 72 with glass fibers from a long fiber injection (LFI) dispersed therein is applied on the rear side. Then the foaming mold is closed and the plastic foams up. As an alternative, the foil 12 is provided with an injection-molded backing.

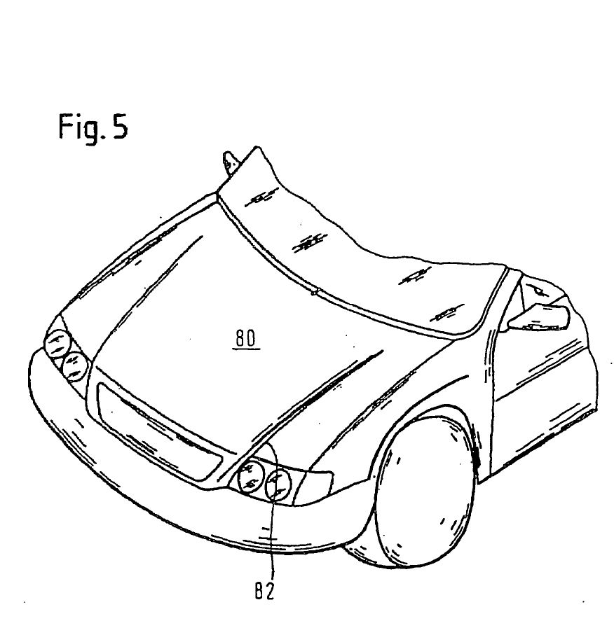

In FIG. 5 there is illustrated a second embodiment of a composite component produced according to the invention, namely in the form of an engine hood 80. The engine hood 80 has a step-shaped raised portion starting from a radiator grill, with a lower step forming a bead 82 that extends so as to be elongated and is formed by a corresponding slot in the deep-drawing mold 10.

After having made the foamed backing, a rim area of the composite component is trimmed all around. In FIG. 2 there is shown the future cutting edge, having reference numeral 84.

The trimming takes place in the bead 22, which represents an undercut in the deep-drawing direction (vertical direction). With this, the slots 40, 52, 54, 62 are situated in the visible region of the composite component and not in the region where the trimming is performed.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of producing a composite component having a foil defining an outer skin of a finished composite component, comprising the following steps:
a) using a deep-drawing mold having at least one of an elongated, angular indentation and raised portion to form an elongated, square-edged bead in the foil, the at least one of the elongated angular indentation and raised portion being formed by two surfaces meeting along a line of intersection (S);
b) placing the foil in a deep-drawing tool provided with the deep-drawing mold;
c) sucking the foil in through a slot provided in the deep-drawing mold and running along the line of intersection (S), the slot constituting an extension of a suction channel; and
d) deep drawing the foil.

2. The method according to claim 1 wherein the composite component is a large-area vehicle body attachment part.

3. The method according to claim 1 wherein the foil is provided with a foamed or injection-molded backing on a side that faces the deep-drawing mold provided with the slot.

4. The method according to claim 1 wherein the foil is a multilayered coextrusion foil that is dyed throughout.

5. The method according to claim 1 wherein the foil has a thickness of at least 1 mm.

6. The method according to claim 1 wherein a plurality of suction channels open out into the slot.

7. The method according to claim 1 wherein the slot has a maximum width of 0.8 mm.

8. The method according to claim 1 wherein the slot has a maximum width of 50% to 60% of a thickness of the foil.

9. The method according to claim 1 wherein the slot has a maximum width that is half a radius of curvature of the deep-drawing mold at the line of intersection (S).

10. The method according to claim 1 wherein the foil is trimmed at a rim area before or after a foamed or injection-molded backing has been applied, the elongated, square-edged bead being situated in a portion of the foil that is not severed.

11. A deep-drawing mold for deep-drawing a foil that is to be provided with a foamed/injection-molded backing comprising:
a deep-drawing mold having a contact surface provided for a foil and comprising at least one of an elongated indentation and a raised portion formed by two surfaces meeting along a line of intersection, and a suction channel being provided in the deep-drawing mold; and
wherein along the line of intersection (S) the contact surface has an elongated slot in fluid communication with the suction channel.

12. The deep-drawing mold according to claim 11 wherein the elongated slot extends essentially along an entire length of the at least one of the elongated indentation and raised portion.

13. The deep-drawing mold according to claim 11 including a plurality of suction channels that open out into the elongated slot.

14. The deep-drawing mold according to claim 11 wherein the at least one of the elongated indentation and raised portion has one of a U-shaped and V-shaped cross-sectional shape having corners that are each provided with one elongated slot.
